(19) United States
(12) Patent Application Publication
(10) Pub. No.: US 2015/0002261 A1
(43) Pub. Date: Jan. 1, 2015

(54) METHOD AND SYSTEM FOR CERTIFYING THE PRESENCE OF AN OPERATOR

(71) Applicant: SIXS S.R.L. -SOLUZIONI INFORMATICHE PER IL SOCIALE, Milano (MI) (IT)

(72) Inventors: Sebastiano Schiavi, Vaiano Cremasco (IT); Graziano Panzera, Rezzato (IT)

(21) Appl. No.: 14/372,173

(22) PCT Filed: Dec. 19, 2012
(86) PCT No.: PCT/IB2012/057457

§ 371 Date: Jul. 14, 2014

(30) Foreign Application Priority Data
Jan. 12, 2012 (IT) MI2012A000028

(51) Int. Cl. G07C 1/20; G07C 1/10

(52) U.S. Cl. CPC G07C 1/20; G07C 1/10
USPC 340/5.8

(57) ABSTRACT

A method for certifying the presence of an operator includes a presence code (104) requested (202) at a given time instant (21, 22) to a first device (103) operable by a user (102); the first device (103) generates (203) the presence code (104), the presence code (104) including a portion generated according to an encoding algorithm (25), wherein the generated portion depends on the time instant (21, 22) and on an identifier (23) of the first device (103); a second device (105) operable by an operator (101) stores (204) the generated presence code (104); the presence code (104) is transmitted (109) to a third validation device (108); the third validation device (108) certifies (212) the presence of the operator (101) at the user (102) at the time instant (21, 22); the certification (212) including: providing the third validation device (108) with at least one piece of time information (21, 206, 306) about the time instant (21, 22), and further providing (205) the identifier (23) of the first device (103), wherein the presence code (104) is validated (208) by comparing it (26) with at least one second presence code (27) generated (25) by the third validation device (108) according to the same encoding algorithm (25) and according to the piece of time information (21, 206, 306) and according to the identifier (23), wherein certification (212) occurs if the comparison (26) shows a match between the presence code (104) and the second presence code (27).

### TECHNICAL FIELD

The present invention relates to a method and a system for certifying the presence of an operator.

In general, the present invention is applicable to the field of identification and verification of the presence of operators at specific users, e.g. in places of interest.

### PRIOR ART

In many activities there is a need for detecting the presence of operators providing different kinds of services to different users. For example, it may be necessary to detect the presence of workers at a building site, even a mobile one. Also, it may be necessary to detect the presence of medical operators, e.g. for home nursing. Likewise, it may be necessary to detect the presence of workers carrying out industrial or domestic cleaning tasks, operators in the transportation field, etc.

In particular, in activities like those exemplified above and in other activities as well, there is a need for not only detecting the presence of an operator, but also for accurately certifying the provision of a given service to a user, whatever the nature or mode of the service provided by the operator.

It is known that RFID technologies are currently being used for detecting an association between a badge programmed for identifying a user and a dedicated apparatus, typically an “electronic stamper”, which can record a badge identifier, the date, the time and any additional codes such as, for example, service identifiers, and then transmit these data to an application (via wired or wireless connections or by transfer to a mass memory such as a USB device) for presence processing. These known systems, however, although useful for automatic presence collection, do not allow presences to be certified with an adequate level of security, since identification badges can be easily transferred from one person to another, and the presences themselves can be easily altered before being transmitted to the customer. Document US2005/0035863A1 describes a system for verifying the presence of security personnel in predetermined places within preset time windows. According to the system of US2005/0035863A1, a person enters a predetermined identification code and any additional messages, which are then transmitted to a central server. The information sent is compared with predetermined parameters, so as to generate an alarm if the information entered is not coherent with such predetermined parameters. The system known from US2005/0035863A1 has the drawback that it requires real-time transmission of the entered data, i.e. it requires the presence of a dedicated connection, which however might be difficult to install in many workplaces, such as domestic environments or open building sites.

Document WO91/06926 and the corresponding patent U.S. Pat. No. 5,058,161 describe a method and an apparatus for identifying personnel and certifying their presence at predetermined stations. According to document WO91/06926, each person to be identified carries a badge that stores a code which is at least partly variable in a predetermined manner at different time instants. The badge is responsive to a trigger signal, e.g. emitted when the person arrives at a predetermined station; the badge response to the trigger signal includes the transmission of at least said code. When it receives the code emitted by the badge, the station can identify the person and certify his/her presence within a given time interval; for this reason, the station compares the code received from the badge with codes stored or generated by the system, and will identify the person if the codes match. The method and the apparatus described in WO91/06926, however, suffer from the drawback that, in order to verify at a central level the presence of individuals identified at multiple stations, all such multiple stations must be connected to one another, e.g. through a central processor. A system like the one disclosed in WO91/06926 would therefore be difficult to install in many workplaces, such as, for example, domestic environments or open building sites.

Document WO2004/025575A1 relates to a system for monitoring the presence of a “service provider” at a “remote location”, which system employs a device that shows date and time information and has a unique identification number. Said device generates a dynamic code based on the current date and time and on the identification number. The user checking the code sends an SMS message to a receiver, which then unpacks the code and determines the instant of generation and the identifier of the generation device. The system known from WO2004/025575A1, however, suffers from the drawback that the information, though encoded, is transmitted in a non-optimal way as far as certification security is concerned. Any tampering of the code according to WO2004/025575A1 would, in fact, create significant security problems, since all information, though encrypted, is contained in the code itself, and an ill-intentioned user would have access to it. At the same time, the generated code may need to have a considerable length to be able to contain the encoded information; this fact may involve difficulties in the subsequent code transmission and storage steps.

### BRIEF DESCRIPTION OF THE INVENTION

The present invention aims at providing a method and a system for certifying the presence of an operator, which allow solving some problems of the prior art.

In particular, it is one object of the present invention to provide a method and a system for certifying the presence of an operator which ensure improved security by certifying the presence of a given operator in a more effective manner.

It is another object of the present invention to provide a method and a system for certifying in a simple manner the presence of a given operator at a user in a given geographic position, at a given instant or within a given time interval, wherever the user is located, whether fixed or mobile, and at any moment.

It is a further object of the present invention to provide a method and a system for certifying the presence of an operator which allow monitoring a plurality of users, even mobile ones, at different time instants, in order to certify the presence of an operator.

Finally, it is yet another object of the present invention to provide a method and a system for certifying the presence of an operator which allow monitoring and certifying, even at a central level, the provided services, so as to implement a monitoring of the services provided to users by the operators.

These and other objects of the present invention are achieved through a method and a system for certifying the presence of an operator incorporating the features set out in the appended claims, which are intended to be an integral part of the present description.

A general idea at the basis of the present invention is to provide a method for certifying the presence of an operator, wherein a presence code is requested, at a given time instant, to a first device operable by a user; the first device generates the presence code, which comprises a portion generated according to an encoding algorithm dependent on the time instant of generation and on an identifier of the first device; a second device operable by an operator stores the presence code thus generated, and the presence code is then transmitted to a third validation device. The third validation device certifies the presence of the operator at the user at said time instant, receiving at least one piece of time information about the time instant of generation and further receiving the user identifier; the presence code is validated by comparing it with at least one second presence code directly generated by the third validation device according to the same encoding algorithm based on the time information and the identifier; certification is achieved when the comparison shows a match between the presence code and the second presence code.

The proposed method offers the advantage of higher certification security, since the code employed makes it impossible to fraudulently reconstruct the information upon which the code generation process is based. In this manner, in fact, it is more difficult to counterfeit the code to transmit fake information that might then be successfully validated and certified.

In addition, the method allows validating and certifying the presence of the operator without requiring a direct connection between the user's first device and the third validation device. In this manner, at any time instant it is possible to certify the presence of an operator at any user, whether fixed or mobile.

Furthermore, it is advantageously possible to monitor, simultaneously and effectively, a plurality of users, even mobile ones, thanks to the use of the second device operable by the operator; in fact, a plurality of code generation devices having different identifiers are respectively associated with the various users. This allows certifying and monitoring at a central level the services provided by operators to different users.

In other words, the third validation device is additionally given a time indication relating to the time instant at which the code was requested, and an identifier of the user to whom it was requested. This information may be transmitted to the third validation device by the operator or, even automatically, by the second device. The presence code is then validated by comparing it with a second presence code, which is subsequently generated by the third validation device by using the same said encoding algorithm, as if it were generated at the same time instant as the request, and for the same user identifier. In this manner, by verifying the coherence between the information relating to the presence of the operator and the code generated and transmitted, it is possible to certify the presence of the operator by using presence codes having a reduced length, thereby simplifying the transmission and storage thereof by means of various different technologies.

This enhances security even further, while at the same time making it less exacting for the verification device to interpret the presence code.

In a preferred embodiment, the second device requests the generation of the presence code to the first device, which step may also occur automatically, e.g. when the two devices are brought near, even without touching each other. In this case, the first device transmits the presence code to the second device; also, the second device preferably transmits the presence code to the third validation device automatically, e.g. when it is connected thereto, whether physically or via a wireless connection, thereby allowing the data to be downloaded to the third validation device. The automation of the transmission of the presence code results in an easier certification procedure for the users and/or the operators.

Preferably, the presence code is transmitted by means of wireless devices, e.g. of the RFID or Bluetooth type, resulting in simpler and faster interaction between the devices. In a preferred embodiment, the distance between the first device and the second device, or the geographic position of at least one of said devices, is verified as soon as the presence code is requested, so that the code will only be generated or stored if the distance is shorter than a predetermined distance or the geographic position is within a predetermined area. This further improves certification security, since it prevents any abuse by the operator even should the user be his/her accomplice.

Preferably, the encoding algorithm generates codes having limited time validity and based on the current time. In this manner, it is possible to univocally certify the presence of the operator on the basis of the generated codes, as well as to improve the security of 2 0 the certification system by preventing any tampering.

Preferably, the codes employed are of the TOTP type, i.e. Time based—One Time Password, based on the OATH (Open AuTHentication) standard.

Preferably, the generation and validation of the codes are both carried out by means of synchronized clocks, so that the presence of the operator can also be certified for monitoring the services being provided, e.g. for invoicing or verification purposes.

Preferably, supplementary information is also sent to the third validation device along with the presence code, such as: service provided, entry/exit, workplace geographic coordinates.

The present invention further relates to a system for certifying the presence of an operator, comprising a first device operable by a user, which is adapted to generate a presence code that comprises a portion generated according to an encoding algorithm dependent on the time instant of generation and on an identifier of the first device, and further comprising a second device operable by an operator, which comprises a memory area for storing the presence code, and further comprising a third validation device adapted to receive the presence code, wherein the third validation device is adapted to provide presence certification by validating the presence code. The third validation device is in fact adapted to receive at least one piece of time information about the time instant, and to further receive the identifier; the third validation device is then adapted to validate the presence code by generating at least one second presence code according to the same algorithm (25) and according to the time information and to the identifier (23), and by comparing the presence code with the at least one second presence code generated; the third validation device is therefore adapted to provide certification if the comparison shows a match between the presence code and the second presence code.

It is therefore apparent that a presence certification system thus conceived is specifically adapted to implement the above-described certification method.

The user's first device and the third validation device can thus be independent of each other.

The present invention further relates to a computer and a computer program, which contribute to the execution of steps of the above-described method.

The present invention also relates to a mobile terminal operable by an operator, which contributes to the execution of steps of the above-described method.

Further objects and advantages of the present invention will become more apparent from the following detailed description and from the annexed drawings, which are supplied by way of non-limiting example.

### BRIEF DESCRIPTION OF THE DRAWINGS

In the drawings referred to in the description, the same reference numerals designate the same or equivalent elements or actions.

FIG. 1 schematically illustrates one embodiment of the system for certifying the presence of an operator according to the present invention;

FIG. 2 exemplifies the certification and validation of a presence code according to the present invention;

FIG. 3 schematically illustrates a first method for certifying the presence of an operator according to the present invention;

FIG. 4 schematically illustrates a second method for certifying the presence of an operator according to the present invention;

FIG. 5 schematically illustrates a third method for certifying the presence of an operator according to the present invention;

FIG. 6 schematically illustrates a fourth method for certifying the presence of an operator according to the present invention;

FIG. 7 schematically illustrates a fifth method for certifying the presence of an operator according to the present invention;

FIG. 8 schematically illustrates a sixth method for certifying the presence of an operator according to the present invention.

### DETAILED DESCRIPTION

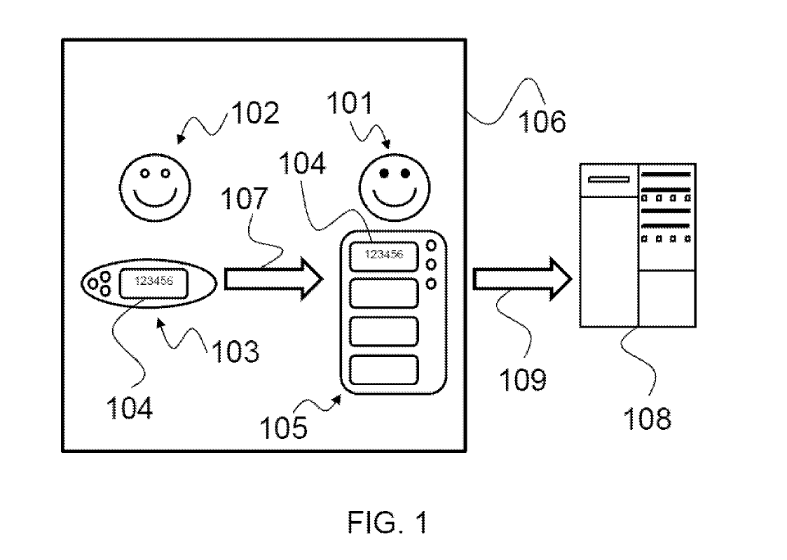

FIG. 1 illustrates one example of the system for certifying the presence of an operator according to the present invention. The operator 101 goes to a user 102, exemplified herein as a person, e.g. a sick person who requested home assistance from a nurse 101. The user 102 may also be a physical place or a machinery in other application examples. The user 102 is equipped with a device 103 for generating a presence code 104; preferably, the device 103 is a “token”, i.e. a small portable electronic device powered by a battery lasting a few years, and fitted with a display and/or an interface for data transmission, and optionally with a numeric keypad.

The device 103 is adapted to generate a presence code 104 according to an algorithm dependent on the time instant and on the identifier of the generation device 103.

The algorithm is based on a system for generating passwords having limited time validity and based on the current time (date and time), preferably of the TOTP (Time based one time password) type of the OATH (Open AuTHentication) standard. It follows that, for different time instants (approximated by time intervals having a certain predetermined duration, which is variable from a few seconds to a few hours), the same device 103 will generate presence codes 104 which will be different from one another and from which one can derive the identifier of the generation device 103 and the instant of generation.

It should be noted that, for finite-length presence codes, it may happen that equal codes are generated for time instants which are distant from each other. Those skilled in the art will be able to select the code type, length and structure compatibly with their certification needs, in particular as regards the time interval of interest and the accuracy in determining the time instant, approximated by an interval having selectable width.

The operator 101 is in turn equipped with a device 105 adapted to receive and store the presence code 104. Preferably, the transmission of the code 104 from the device 103 to the device 105 occurs when the two devices are close, i.e. when the operator 101 and the user 102 are in the same position 106. In this manner, it is conceivable that the transmission 107 of the presence code 104 only occurs when the operator 101 is present at the user 102; it is this characteristic that ensures the possibility of presence certification, as will become apparent below.

Preferably, the transmission 107 of the code 104 can be carried out by using various proximity systems, such as an RFID tag or Bluetooth recognition of the devices 103 and 105. In a preferred embodiment, the token 103 is adapted to interface to and communicate with a cellular telephone/smartphone/personal digital assistant 105.

Preferably, the device 105 of the operator 101 is adapted to interface to a plurality of user devices, as well as to store a plurality of presence codes, so as to certify the presence of the operator 101 at a plurality of users, at different instants, during the working day/week/month.

At predefined moments, typically after the service has been provided, the operator 101 sends the presence code(s) stored in the device 105 to a validation device 108, which is adapted to certify the presence of the operator 101 at the user 102, i.e. in the position 106, at a certain time instant.

The validation device 108 preferably comprises an authentication server, with which a clock is associated which was synchronized with a clock of the device/token 103 upon activation.

The transmission 109 of the presence code 104 may directly occur through a telecommunication/cellular system, or presence codes may be entered at a later time (e.g. via software, USB, RFID, Bluetooth, Wi-Fi, etc.), while still preserving the possibility of verifying the moment at which they were generated. In a preferred embodiment, the connection used for the transmission 109 is similar to the connection used for the transmission 107.

The presence codes will be used for certifying the date and time when they were generated and the presence of the operator 101 at the user 102 at the signalled date and time. The presence codes will be validated by the validation device 108 after having been stored therein, by using the same encoding algorithm. As will become more apparent below, the presence code will be compared with at least one second code regenerated by the device 108 itself, by using time information about the instant of generation and the private encryption key of the device 103, which is known to the certifying body, but unknown to the operator 101 and the user 102.

In a preferred embodiment, simultaneously with the transmission 109 further data identifying the service carried out by the operator are also sent, e.g. data entered by the operator 101 himself or transmitted automatically, such data being stored in the device 105 along with the presence code 104.

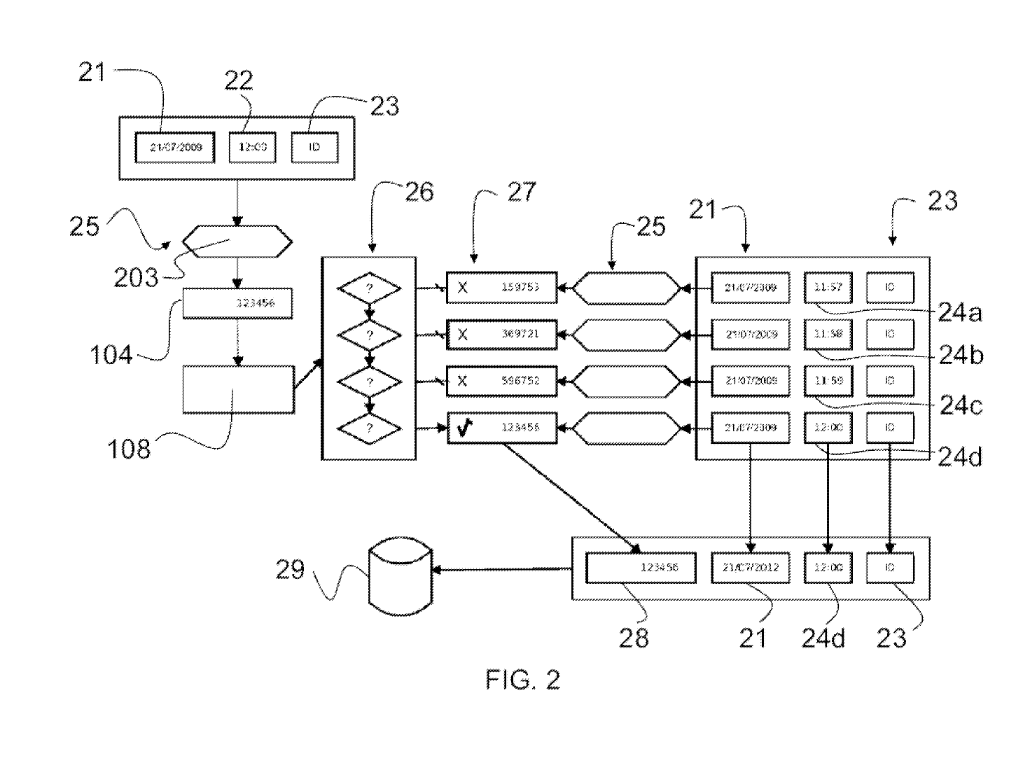

FIG. 2 exemplifies the validation of the presence codes by the validation device 108. The code 104 is generated by an encoding 203 executed by starting from information known to the device 103, i.e. date 21, time 22 and identifier 23 of the device 103, associated with the user 102.

The algorithm that generates the code 104 performs an encryption, preferably through hashing techniques, which uses the date 21 and time 22 information and a private encryption key associated with the identifier 23 to generate a code 104.

Said code 104 is compact and is not directly referable to the original time and user data. In other words, the generation algorithm does not allow to derive directly and univocally the generation instant and/or user from the code 104.

This feature implies many advantages. For example, data transmission security is improved, because a system user, even if he/she knows the method employed for generating the code, will be unable to counterfeit it. Moreover, an ill-intentioned user will not be able to generate any further fake codes starting from previously generated codes. In addition, as will explained more in detail below, it becomes possible to certify the truthfulness of the code, thus certifying the presence of the operator, even after the data have been stored into the validation device 108, which would otherwise be impossible to do after having deleted the code 104 from the memory of the generation device 103.

It thus becomes easier to detect any system tampering or malfunction.

As regards the validation of the code 104, it is sent to the validation device 108, which will then behave as described below.

As a matter of fact, it is necessary to trace the code 104 back to the information about date 22, time 23 and identifier 23 of the generation device 103.

According to the invention, the validation device 108 is given a piece of time information, i.e. the date 22, but not the time 23. The validation device 108 is also given the identifier 23; in this way, the validation device can derive the private generation key of the device 103, without needing the same to be made known to anyone, i.e. neither to the operator 101 nor to the user 102.

The device 108 then considers at least one time instant within the signalled date 21, preferably generating a plurality of presence codes for a respective plurality of time instants 24a, 24b, 24c, 24d.

For each one of these time instants 24a, 24b, 24c, 24d a code is generated by means of an algorithm 25, which is the same algorithm 203 as the one used by the generation device 103.

The validation device 108 then compares 26 each one of the generated codes 27 with the code 104. If the device 108 does not detect a match with a code 27, it will compare the next one.

When the code 18 is arrived at, which matches the presence code 104, the device makes a successful comparison, thereby validating the code 104. The device 108 then stores the information about the date 21, the certified time instant 24d, the identifier 23 of the user 102, and the validated code 28. The presence of the operator 101 is thus certified.

Advantageously, the code 104 has a compact size, and the generation 25 of a plurality of codes 27 is not excessively costly from a computational viewpoint. Likewise, the comparison 26 between the code 104 and the plurality of codes 27 is not excessively burdensome as well. A minimal computational cost increase is however justified by a more secure and reliable certification of the operator's presence.

It is clear that the time interval taken into account (e.g. one day), within which the plurality of codes are generated, may be modified based on the user's operational needs, e.g. by narrowing it to predefined working hours, e.g. from 8:00 AM to 6:00 PM.

It is also conceivable that the accuracy of the time instant 24d has to established with reference to the variability of the code 104 over time, i.e. according to the instant of generation 22. Different approximations of the time instant may be taken into account, e.g. every 5 minutes, every 15 minutes, etc., still according to the users' operational needs.

In an alternative embodiment, also the information about the instant of generation 22 is sent to the validation device 108 in order to provide an initial indication of the priority time interval to be considered for code validation, resulting in shorter code validation times.

Preferably, the presence code 104 contains 6 decimal digits, so that it can be generated, encoded, transmitted and validated in a short time, thus simplifying the implementation of the method of the present invention.

The following will describe a few examples of the method for certifying the presence of an operator according to the present invention, which may be implemented, for example, by means of the above-described system.

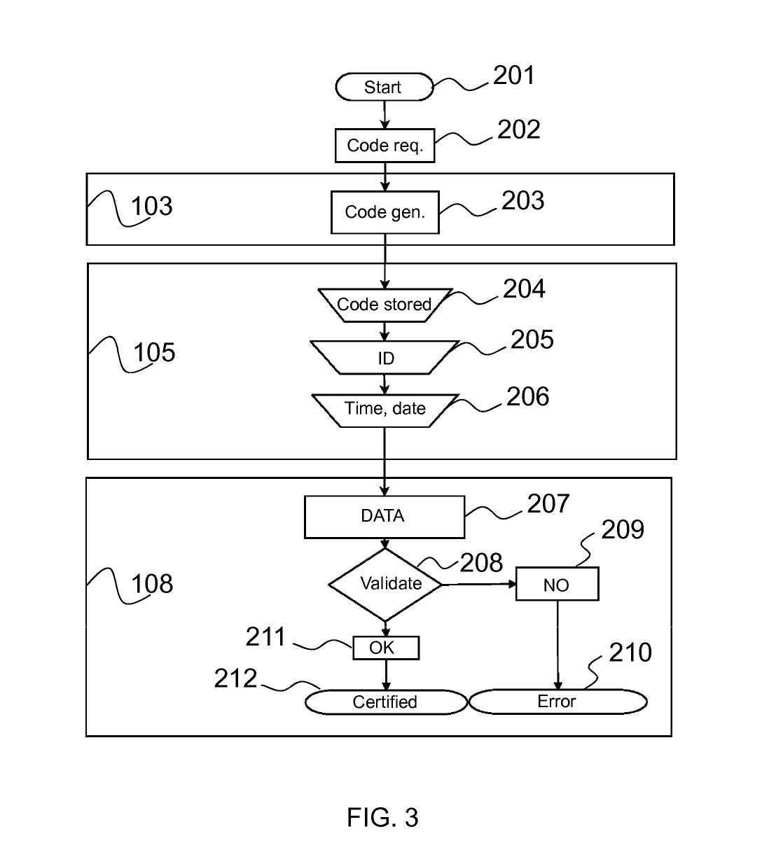

FIG. 3 illustrates a first embodiment of the method, wherein the operator is required to provide information about the user identifier, the date, the time, and a stored presence code.

At step 201 the presence certification method starts; at step 202, a presence code is requested to attest the presence of the operator 101 at the user 102 at that given time instant.

At step 203, the device 103 operable by the user 102 generates a TOTP presence code 104 to be transmitted to the operator.

At step 204, the device 105 operable by the operator 101 receives the code 104 and stores it into a permanent or volatile memory. The device 105 is in the proximity of the device 103. Storing may occur automatically or manually, in which case the operator 101 will write or enter the presence code.

In general, a digital medium will be used for storage purposes, but an analog one may be used as well. It is also conceivable that storage occurs on a non-digital medium, such as, for example, a pre-printed optical reading card, on which the generated presence code will be indicated or encoded.

At step 205, the operator 101 specifies the TOTP identifier of the device 103 (if more than one are active) in order to identify the user 102, and also specifies the service date and time at step 206. This information is stored into the device 105 as well.

At step 207, the device 105 sends to the validation device 108 the stored data, i.e.: presence code, date and time, user identifier.

At step 208, the remote validation device 108, which knows the algorithm and the private key used for generating the codes of the device 103, can validate the code in order to validate the date, time and identifier indicated by the user.

In the event that the validation of the presence code is unsuccessful (step 209), then the validation device will generate, at step 210, an error signal without certifying the operator's presence.

If the presence code is validated successfully, i.e. at step 211 the data match, the validation device will certify, at step 212, the presence of the operator 101 at the user 102.

In general, for this embodiment and the next ones, it must be pointed out that the request, made at step 205, for information about the service date and/or time allows to resolve more easily any ambiguity caused by the possibility that identical codes having finite length are generated for different time instants. In fact, it has been defined that, for services for which the operator specifies both date and time, a code having a length of 6 decimal digits is sufficient to univocally certify the presence. Preferably, in situations wherein presence certification requires wider time intervals, a larger number of decimal digits will have to be used. It has also been defined that, for a monthly time horizon, the preferred code length is 8 decimal digits.

It will be apparent to the man skilled in the art that, should it be necessary to certify the duration of a service provided by an operator, i.e. when he/she entered/exited a user's site, it will be sufficient to carry out the method described herein by generating two “parallel” presence codes, one relating to the operator's entry/service start and one relating to the operator's exit/service end. Alternatively, an embodiment is also conceivable wherein the presence code is also associated with a time duration to be certified in addition to the time instant of code generation.

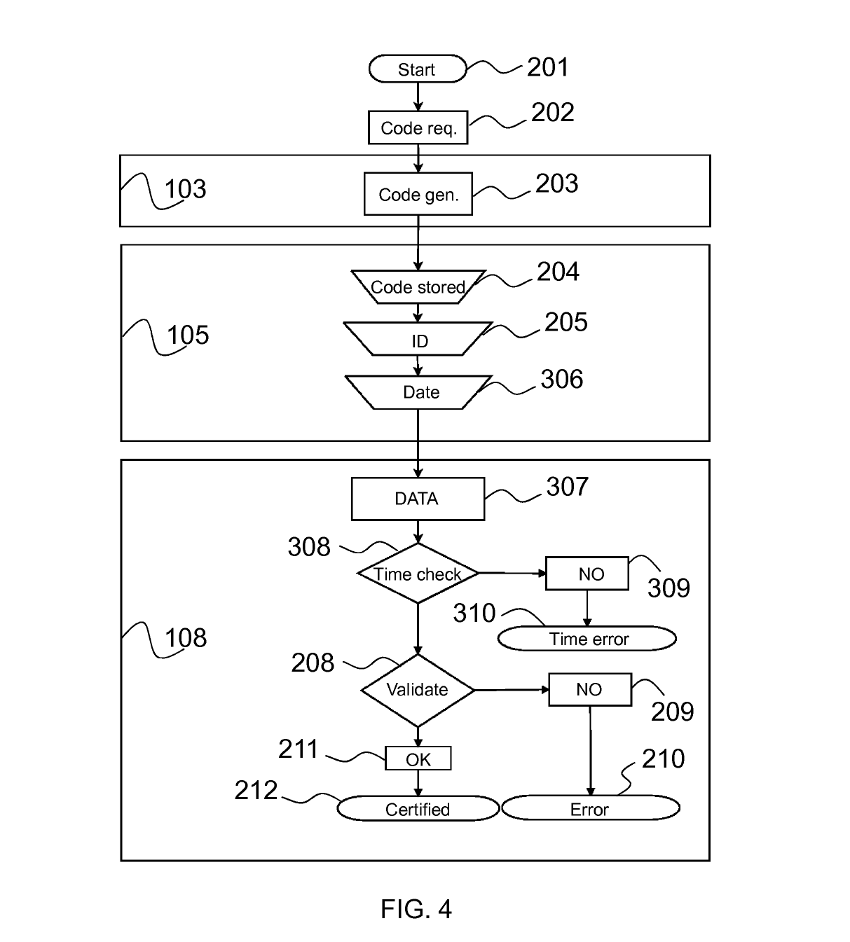

FIG. 4 illustrates a second embodiment of the method, wherein the operator is required to signal a user identifier, the date, and a stored presence code. The validation device 108 automatically provides time recognition; this embodiment is particularly advantageous when the certification system is used as a “stamper”, so that the operator does not have to worry about the date/time.

At step 201 the presence certification method starts; at step 202, a presence code is requested; at step 203, the device 103 operable by the user 102 generates a presence code 104, which is then stored at step 204 by the device 105 operable by the operator; at step 205, the operator specifies the identifier of the device 103.

At step 306, the operator specifies the service date only, and this information is stored into the device 105.

At step 307, the device 105 sends to the validation device 108 the stored data, i.e.: presence code, date, user identifier.

At step 308, the remote validation device 108 validates the time instant (i.e. the time of entry/exit, start/end) signalled through the validation of the presence code(s), by using the same encoding algorithm, as described above. If the time instant information turns out to be invalid (step 309), e.g. outside predefined tolerances (thus implying unrealistic service durations, such as several months, or future or remote times), at step 310 a time error signal will be generated and the operator's presence will not be certified.

If the time validation is successful, then the method will go on by validating the data received by the validation device 108 (step 208).

If the presence code is validated successfully (step 211), at step 212 the presence of the operator 101 at the user 102 will be certified. Otherwise, the already described steps 209 and 210 will be carried out.

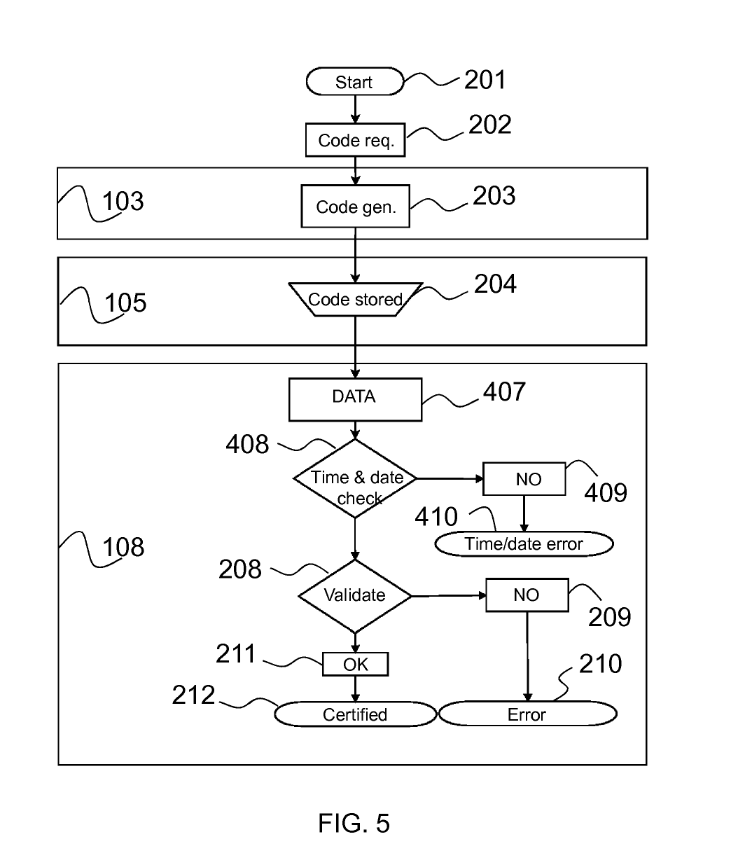

FIG. 5 illustrates a third embodiment of the method, wherein the operator is only required to provide the user identifier and to store a presence code. The validation device 108 automatically recognizes the date of generation, which may be encoded, for example, in the presence code 104; this embodiment is also particularly advantageous when the certification system is used as a “stamper”, so that the operator does not have to worry about the date/time.

Furthermore, this embodiment is particularly advantageous because it ensures a higher level of system automation by requiring minimal human intervention.

At step 201 the presence certification method starts; at step 202, a presence code is requested; at step 203, the device 103 operable by the user 102 generates a presence code 104, which is then stored at step 204 by the device 105 operable by the operator.

At step 407, the device 105 sends to the validation device 108 the presence code stored together with the user identifier.

At step 408, the remote validation device 108 validates the presence code(s) by comparing them with codes regenerated by means of the same generation algorithm, by using the private key of the device 103.

Preferably, the validation device 108 generates a series of codes for a specified plurality of different time instants, as described with reference to FIG. 2.

If the date/time information turns out to be invalid (step 409), e.g. outside predefined tolerances (thus implying unrealistic service durations, such as several months, or future or remote times), at step 410 a time error signal will be generated and the operator's presence will not be certified.

If the time validation is successful, then the method will go on by validating the data received by the validation device 108 (step 208).

If the presence code is validated successfully (step 211), at step 212 the presence of the operator 101 at the user 102 will be certified. Otherwise, the already described steps 209 and 210 will be carried out.

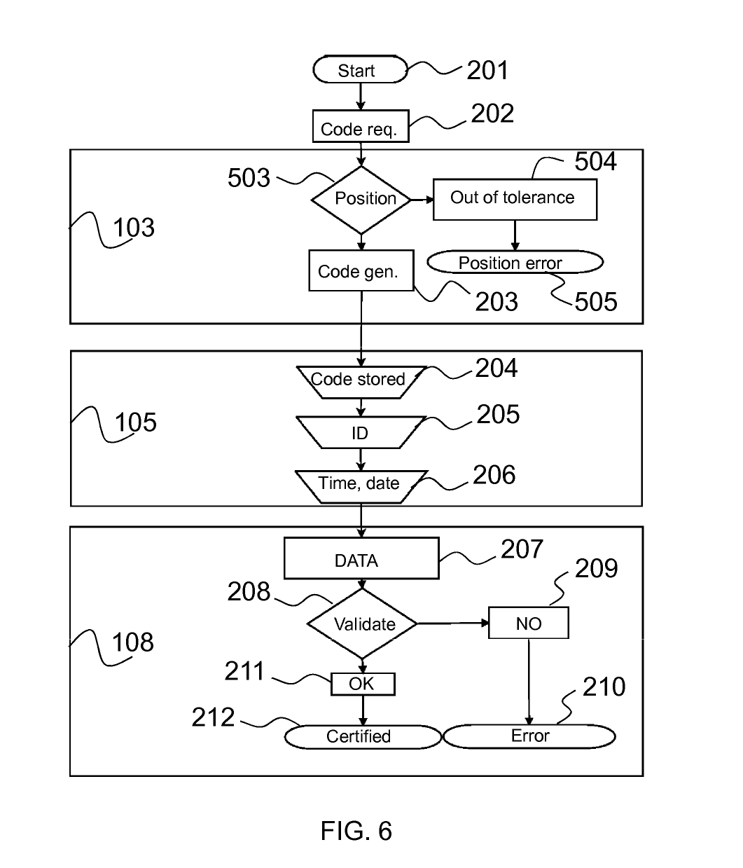

FIG. 6 illustrates a fourth embodiment of the method, wherein a device 103 is used for generating the presence code, which device is equipped with a geographic position recognition system: for example, the TOTP token can verify, by using a GPS receiver or a GSM/cellular location system, to be in a valid position prior to generating the code. This embodiment is particularly suitable for improving the security and accuracy of certification by further limiting the possibility of abuse.

At step 201 the presence certification method starts; at step 202, a presence code is requested.

At step 503, the generation device 103 verifies its own geographic position, e.g. by acquiring it by means of a GPS antenna, or by verifying the cell identifier of a cellular network, or through other known methods.

If at step 504 the geographic position of the device 103 is out of a predefined tolerance, a position error will be generated at step 505 and the generation of the presence code will be prevented.

If, on the contrary, the generation device 103 is in an “allowed” geographic position, such as the position 106, at step 203 a presence code 104 will be generated. According to this embodiment, it is possible to prevent any abuse wherein the generation device 103 is fraudulently separated from the user 102 to be then improperly used for generating authentic presence codes when the operator is not actually at the user's site in the position 106.

The presence code 104 is then stored (step 204) by the device 105 operable by the operator; at step 205, the operator specifies the identifier of the device 103, and at step 206 he/she specifies the date and time; this information is stored into the device 105.

At step 207, the device 105 sends to the validation device 108 the stored data, i.e.: presence code, date and time, user identifier, possible geographic position approval.

At step 208, the validation device 108 goes on by validating the data received by the validation device 108.

If the presence code is validated successfully (step 211), at step 212 the presence of the operator 101 at the user 102 will be certified. Otherwise, the already described steps 209 and 210 will be carried out.

In general, in this embodiment, in the event that the position check carried out at step 503 is unsuccessful, the system will recognize to be in an invalid situation and will communicate the error to the user, thereby refusing to certify the presence. The position check may, for example, be carried out through a GPS system, or by recognizing the position through the cellular network, e.g. through known A-GPS or triangulation systems.

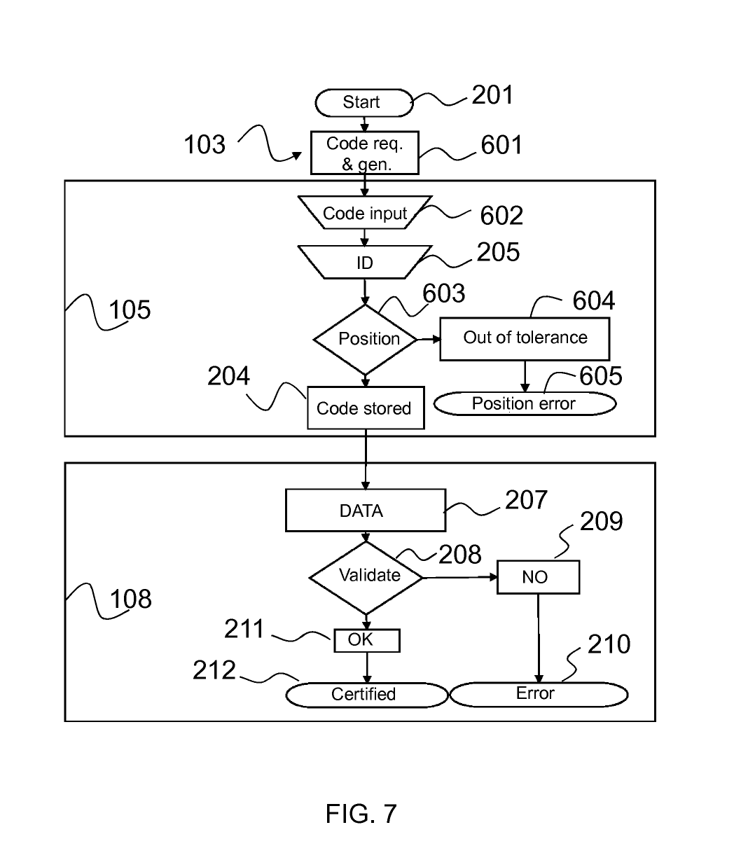

FIG. 7 illustrates a fifth embodiment of the method, wherein a device 105 operable by the operator 101 is used for storing the presence code, which device is also equipped with a geographic position recognition system, e.g.: a GPS receiver or a GSM/cellular location system.

This embodiment is particularly suitable for improving the security and accuracy of certification; at the same time it allows an operator to certify his/her own presence at a plurality of users, which may also be devices 103 not equipped with location systems, since the latter must include, for example, GPS antennas and may therefore be bulky or require a power supply that might not be readily available.

At step 201 the presence certification method starts.

At step 601, a presence code is requested, which is generated by the user, e.g. automatically, by bringing the device 105 near a device 103, e.g. positioned at a building site or in a hospital.

The presence code 104 is then entered (step 602) into the device 105 operable by the operator, whether automatically or manually; at step 205, the operator specifies the identifier of the device 103; this information is stored into the device 105.

At step 603, the device 105 operable by the operator verifies its own geographic position, e.g. by acquiring it by means of a GPS antenna, or by verifying the cell identifier of a cellular network, or through other known methods.

If at step 604 the geographic position of the device 105 is out of a predefined tolerance, a position error will be generated at step 605 and the presence code will be deleted.

If, on the contrary, the generation device 105 is in an “allowed” geographic position, such as the position 106, at step 204 the presence code 104 will be validated as regards its position of origin and will be definitively stored into the device, with effects equivalent to the generation of the code as described for the previous examples.

According to this embodiment, it is possible to prevent any abuse wherein the generation device 103 is fraudulently separated from the user 102 to be then improperly used for generating authentic presence codes when the operator is not actually at the user's site in the position 106.

At step 207, the device 105 sends to the validation device 108 the stored data, i.e.: presence code, user identifier, approval of the geographic position of origin.

At step 208, the validation device 108 goes on by validating the data received by the validation device 108, in accordance with the previous description.

If the presence code is validated successfully (step 211), at step 212 the presence of the operator 101 at the user 102 will be certified. Otherwise, the already described steps 209 and 210 will be carried out.

In this embodiment, if the device 105 is a cellular telephone connected to the network, the position checks can be carried out by software present in the telephone itself.

In addition or as an alternative, at step 601 the generation device 103 may be equipped with a proximity recognition system: prior to generating the presence code, the actual presence of the operator 101 in the environment 106 in the proximity of the user 102 will have to be confirmed by evaluating the distance therefrom. The distance between the two devices may generally be estimated through the proximity of an RFID or Bluetooth system (e.g. recognized through its own mac-address), i.e. it may be computed by knowing the geographic position of both devices (if they are equipped with locating means, e.g. GPS, or if at least the device 103 can be located and the user 102 is fixed). The system will refuse to generate the presence code, if the proximity of the device 105 is not verified.

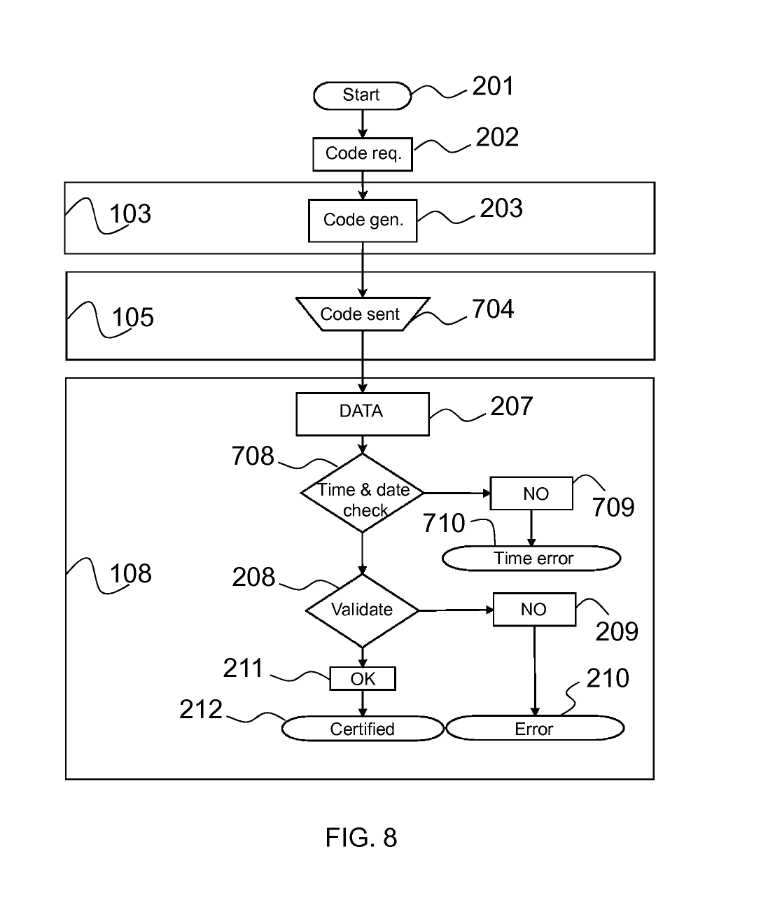

FIG. 8 illustrates a sixth embodiment of the method, wherein the device 105 operable by the operator can connect to the cellular network and comprises position recognition systems.

At step 201 the presence certification method starts; at step 202, a presence code is requested; at step 203, the device 103 operable by the user 102 generates a presence code 104.

At step 704, the presence code is temporarily stored into the device 105, which then verifies that its own position is within a valid geographic area and, if it is, will send the code to the remote validation device 108, along with the geographic position.

At step 704, the device 105 sends to the validation device 108 the stored data, preferably through the SMS protocol, or through a data connection of a different kind.

At step 207, the remote validation device 108 receives the data transmitted by the device 105.

At step 708, the remote validation device 108 receives the information about the time instant (i.e. date/time of entry/exit, start/end) and the position information. If at step 709 at least one of said pieces of information turns out to be invalid, at step 710 a time/position error will be generated and the operator's presence will not be certified.

If, on the contrary, the time/position validation is successful, then the method will go on by validating the data received by the validation device 108 (step 208), in accordance with one of the above-described methods.

If the presence code is validated successfully (step 211), at step 212 the presence of the operator 101 at the user 102 will be certified. Otherwise, the already described steps 209 and 210 will be carried out.

It must finally be pointed out that the same presence code generation algorithm is implemented by both the code generation device operable by the user, e.g. the token, and the authentication server associated with the remote validation device, with which the token's clock is preferably synchronized.

The presence codes may therefore appear to be pseudorandom to both the operator and the user, but they are encoded by the generation devices and validated by the validation devices, though no communication exists between the two devices, so long as the necessary information is known, such as the private key associated with the user identifier (which is only known to the manager of the presence certification system). In fact, the user's device and the validation device are preferably independent of each other, and the operator's device does not need to know the algorithm that generates the presence codes, since it only has to transport them.

In general, it is conceivable to combine the features of each one of the above embodiments with one or more features of other embodiments, in particular whenever the man skilled in the art should find them to be compatible or at least not conflicting with one other.

The present invention therefore provides a method and a system for certifying the presence of an operator which does not require a dedicated connection between the presence detection system 103 and the certification system 108. The detection of the operator's presence is certified by using “Time based-One-Time-Password” codes. It will thus also be possible, in addition to detecting the operator's presence, to certify the truthfulness of the datum also in the event that it is not immediately sent by means of telecommunication connections.

The method of the present invention can be implemented through a computer operating as a validation device 108 and comprising a computer program specifically adapted to carry out a validation 208 for certifying the presence of an operator in accordance with the present invention.

In general, the man skilled in the art may conceive solutions alternative to those which have been described in the present description for illustration purposes, without however departing from the protection scope set out in the appended claims.

1. A method for certifying the presence of an operator, comprising the following steps:
a presence code being requested at a given time instant to a first device operable by a user;
said first device generating said presence code, wherein said presence code comprises a portion generated according to an encoding algorithm, wherein said generated portion depends on said time instant and on an identifier of said first device;
a second device operable by an operator storing said generated presence code;
said presence code being transmitted to a third validation device;
said third validation device certifies the presence of said operator at said user at said time instant,
wherein said certification comprises:
providing said third validation device with at least one piece of time information about said time instant, and further providing said identifier of said first device, wherein said presence code is validated by comparing it with at least one second presence code generated by said third validation device according to the same said encoding algorithm and according to said at least one piece of time information and according to said identifier, wherein said certification occurs if said comparison shows a match between said presence code and said at least one second presence code.

2. A method according to claim 1, wherein said presence code is validated by comparing it with a plurality of further presence codes generated by said third validation device for a respective plurality of time instants within a time interval dependent on said at least one piece of time information.

3. A method according to claim 2, wherein said piece of time information relates to the date of generation of said presence code.

4. A method according to claim 1, wherein said identifier of said first device is associated with a private encryption key for generating said presence code.

5. A method according to claim 1, wherein said encoding algorithm is such as to not allow to univocally and directly derive said time instant from said generated presence code.

6. A method according to claim 1, wherein said encoding algorithm generates presence codes having limited time validity and based on the current time.

7. A method according to claim 6, wherein said algorithm comprises hashing functionalities.

8. A method according to claim 6, wherein said presence codes are of the Time-based-One-Time-Password type, based on the Open-AuTHentication standard.

9. A method according to claim 1, wherein said second device transmits said presence code to said third validation device.

10. A method according to claim 9, wherein said second device requests said presence code to said first device, and wherein said first device transmits said presence code to said second device upon receiving said request.

11. A method according to claim 10, further comprising the step of verifying the geographic position of said first device and/or of said second device upon issuing said request, wherein said presence code is only generated or transmitted if said geographic position is within a predetermined area.

12. A method according to claim 9, wherein said presence code is transmitted through wireless devices, preferably RFID or Bluetooth devices.

13. A method according to claim 10, further comprising the step of verifying the distance between said second device and said first device upon issuing said request, wherein said presence code is only generated or stored if said distance is shorter than a predetermined distance.

14. A system for certifying the presence of an operator, comprising:
a first device operable by a user, which is adapted to generate a presence code that comprises a portion generated according to an encoding algorithm dependent on the time instant at which said generation occurs and on an identifier of said first device, and
further comprising a second device operable by an operator, which comprises a memory area for storing said presence code, and
further comprising a third validation device adapted to receive said presence code, wherein said third validation device is adapted to certify said presence by validating said presence code, said third validation device being adapted to receive at least one piece of time information about said time instant, and to further receive said identifier,
wherein said third validation device is adapted to validate said presence code by generating at least one second presence code according to the same said encoding algorithm and to said at least one piece of time information and to said identifier, and by comparing said presence code with said at least one second presence code generated, wherein said third validation device is adapted to provide said certification if said comparison shows a match between said presence code and said at least one second presence code.

15. A system for certifying the presence of an operator that is configured to implement the method according to claim 1.

16. A computer comprising a program specifically adapted to implement a validation of a presence code for certifying the presence of an operator, wherein said certification is carried out through the method claim 1.

17. (canceled)

18. A mobile terminal operable by an operator, comprising a memory area for storing a presence code, and further comprising processing means configured for certifying the presence of an operator, wherein said certification is carried out through the method claim 1.

19. A computer readable storage media comprising non-transitory instructions that, when run on a computer system, implement a validation of a presence code for certifying the presence of an operator, wherein said certification is carried out through the method of claim 1.
